(19) United States
(12) Patent Application Publication
(10) Pub. No.: US 2014/0247038 A1
(43) Pub. Date: Sep. 4, 2014

(54) FAN SPEED TESTING DEVICE

(71) Applicants: HONG FU JIN PRECISION INDUSTRY (ShenZhen) CO., LTD., (US); HON HAI PRECISION INDUSTRY CO., LTD., New Taipei (TW)

(72) Inventors: KANG WU, Shenzhen (CN); BO TIAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/861,397

(22) Filed: Apr. 12, 2013

(30) Foreign Application Priority Data
Mar. 1, 2013 (CN) 201310065822.3

(51) Int. Cl. G01P 3/489

(52) U.S. Cl. CPC G01P 3/489
USPC 324/166

(57) ABSTRACT

A fan speed testing device is provided. The device includes a power jack, a voltage conversion module, a first fan connector, a DIP switch, and a control module. The first fan connector receives voltage from the power jack and outputs a PWM signal to a fan, receives a first feedback signal from the fan, and outputs the first feedback signal to the control module. The control module receives the predetermined voltage, sets the rotation speed of the fan as marked or predicted by the manufacturer, and outputs the generated PWM signal to the first fan connector. The control module further analyzes the first feedback signal to determine an actual rotation speed of the fan, and outputs the predicted rotation speed of the fan and the first actual rotation speed of the fan, by visual or audible signal to the user for comparison purposes.

### BACKGROUND

1. Technical Field

The present disclosure relates to testing devices and, more particularly, to a fan speed testing device.

2. Description of Related Art

During operation of computers, for example, some electronic components, such as CPUs, may generate a lot of heat. Fans in the electronic devices are employed to dissipate heat. Usually, the electronic device employs a number of thermal sensors to detect the temperature of the electronic components. Each sensor is used to detect the temperature of an electronic component. The electronic device generates a PWM signal containing a unique duty cycle corresponding to the detected temperature of one sensor and outputs the PWM signal to the fan cooling the component with the sensor to control the fan to rotate with a certain rotation speed. However, depending on the type, manufacturer, and usage time of the fan, the rotation speed may not reach one certain rotation speed when the same PWM signals are sent to different fans. Thus, the heat emitted by some electronic components may not be dissipated efficiently, which may cause the electronic device to burn out. Therefore, it is desired to provide a fan speed testing device to resolve the above problem.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is one embodiment of a block diagram of a fan speed testing device.

FIG. 2 is a circuit diagram of a voltage conversion module of the fan speed testing device of FIG. 1.

FIG. 3 is a circuit diagram of a first fan connector of the fan speed testing device of FIG. 1.

FIG. 4 is a circuit diagram of a control module of the fan speed testing device of FIG. 1.

FIG. 5 is a circuit diagram of an oscillation module of the fan speed testing device of FIG. 1.

FIG. 6 is a circuit diagram of a display unit of the fan speed testing device of FIG. 1.

FIG. 7 is a circuit diagram of a second fan connector of the fan speed testing device of FIG. 1.

FIG. 8 is a circuit diagram of a buffer module of the fan speed testing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

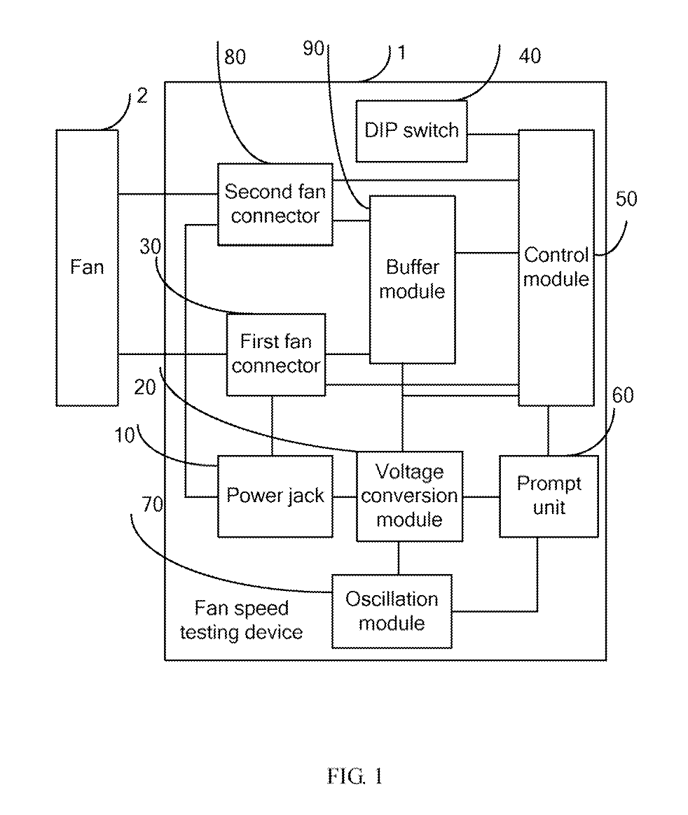

FIG. 1 shows one embodiment of a fan speed testing device 1. The fan speed testing device 1 includes a power jack 10, a voltage conversion module 20, a first fan connector 30, a dual in-line package switch (DIP switch) 40, and a control module 50. The power jack 10 is configured to receive voltage from a power source (not shown) and supply the received voltage to the first fan connector 30. In the embodiment, the voltage received from the power source is 12V. The voltage conversion module 20 is electrically connected to the power jack 10. The voltage conversion module 20 converts the voltage received by the power jack 10 to a predetermined voltage. In the embodiment, the predetermined voltage is 5V. The first fan connector 30 is electrically connected to a fan 2. The control module 50 is electrically connected to the first fan connector 30 and the DIP switch 40. The control module 50 is configured to set a predicted rotation speed of the fan 2 in response to a user operation of setting a particular combination of the DIP switch 40, generate a PWM signal corresponding to the predicted rotation speed of the fan 2, and output the PWM signal to the fan 2 through the first fan connector 30, to control the rotation speed of the fan 2. The control module 50 is further configured to receive a first feedback signal outputted by the fan 2 through the first fan connector 30, analyze the first feedback signal to determine a first actual rotation speed of the fan 2, and inform users about the marked or predicted rotation speed and the first actual rotation speed, either by visual or audible signal. Thus, the user can learn whether the fan 2 is rotating at a desired rotation speed according to a comparison between the predicted rotation speed and the first actual rotation speed of the fan. If the difference between first actual rotation speed and the predicted rotation speed is less than a preset value, the user can determine that the fan 2 is rotating at a satisfactory rotation speed.

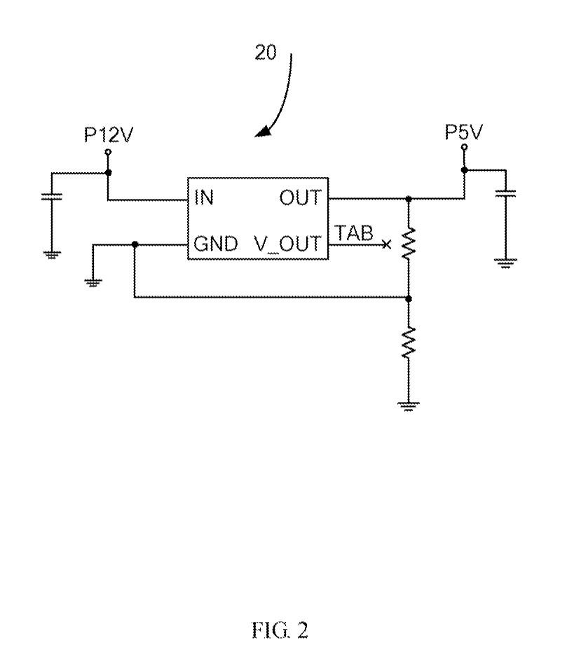

FIG. 2 shows the voltage conversion module 20 of the embodiment. The voltage conversion module 20 includes a voltage input terminal IN and a voltage output terminal OUT. The voltage conversion module 20 is configured to receive the voltage from the power jack 10 through the voltage input terminal IN, convert the received voltage to the predetermined voltage, and output the predetermined voltage through the voltage output terminal OUT. In the embodiment, the voltage conversion module 20 is a TLV1117 chip.

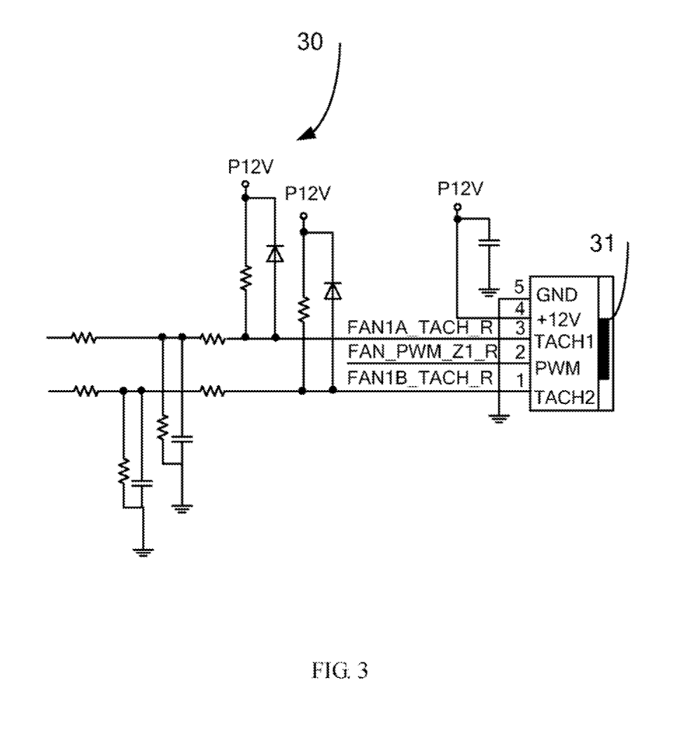

FIG. 3 shows the first fan connector 30 of the embodiment. The first fan connector 30 includes a fan connection terminal 31, a first signal input terminal PWM, a first signal feedback terminal TACH1, and a connector power terminal VCC. The fan connection terminal 31 is electrically connected to the fan 2. The first signal input terminal PWM is electrically connected to the control module 50. The first fan connector 30 receives the PWM signal from the control module 50 through the first signal input terminal PWM and outputs the PWM signal to the fan 2 through the fan connection terminal 31. The first fan connector 30 is further configured to receive the first feedback signal from the fan 2 through the fan connection terminal 31 and output the first feedback signal to the control module 50 through the first signal feedback terminal TACH1. Further, the first fan connector 30 is configured to receive the voltage from the power jack 10 through the connector power terminal VCC. In the embodiment, the first fan connector 30 is a HF0805E chip.

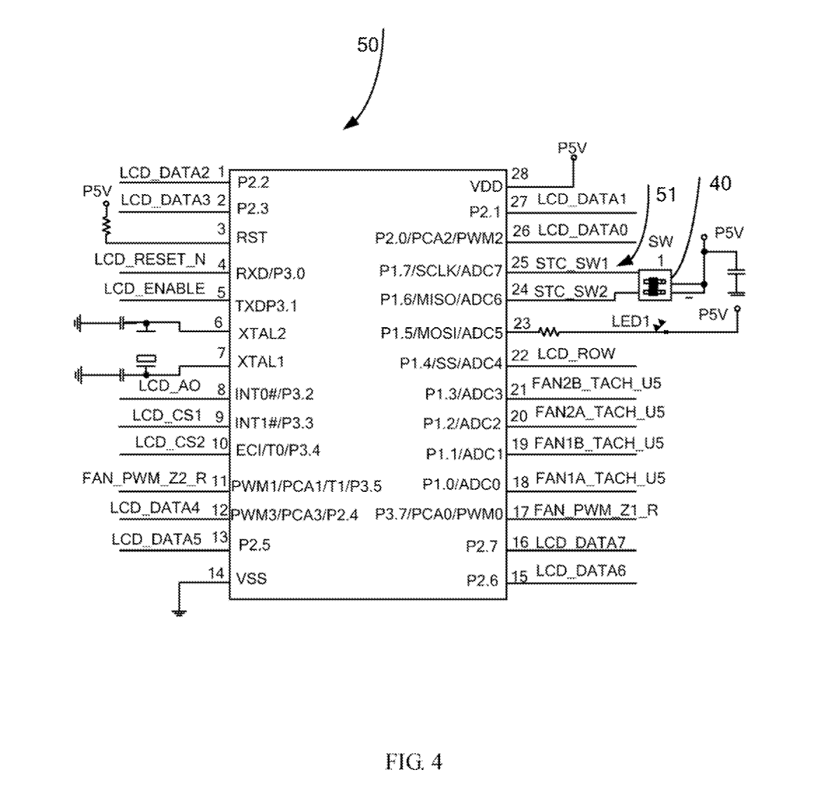

FIG. 4 shows the control module 50 of the embodiment. In the embodiment, the DIP switch 40 comprises two switches. Each switch can provide a one-bit binary value. The two switches offer 4 combinations. The DIP switch is capable of being set by the user operation. Different combinations of the DIP switch 40 correspond to different predicted rotation speeds of the fan 2.

The control module 50 includes a switch signal input terminal 51, a first PWM signal output terminal P3.7/PCA0/PWM0, a first feedback signal input terminal P1.0/ADC0, and a control power terminal VDD. The control module 50 is electrically connected to the DIP switch 40 through the switch signal input terminal 51. The control module 50 sets the predicted rotation speed of the fan 2 in response to the user operation of setting a combination of the DIP switch 40, and generates the PWM signal corresponding to the set predicted rotation speed of the fan 2. In the embodiment, the switch signal input terminal 51 includes a first switch signal input terminal P1.6/MISO/ADC6 and a second switch signal input terminal P1.7/SCLK/ADC7. The control module 50 is electrically connected to the DIP switch 40 through the first switch signal input terminal P1.6/MISO/ADC6 and the second switch signal input terminal P1.7/SCLK/ADC7.

The first PWM signal output terminal P3.7/PCA0/PWM0 of the control module 50 is electrically connected to the first signal input terminal PWM of the first fan connector 30. The control module 50 sets the predicted rotation speed of the fan 2 in response to the user operation of setting a combination of the DIP switch 40, generates the PWM signal corresponding to the set predicted rotation speed of the fan 2, and outputs the generated PWM signal through the first PWM signal output terminal P3.7/PCA0/PWM0 to the first signal input terminal PWM of the first fan connector 30, to control the rotation speed of the fan 2.

The control module 50 is further configured to receive the first feedback signal from the first signal feedback terminal TACH1 of the first fan connector 30 through the first feedback signal input terminal P1.0/ADC0, analyze the first feedback signal to determine the first actual rotation speed of the fan 2, and inform users the predicted rotation speed of the fan 2 and the first actual rotation speed of the fan 2 by visual or audible signal.

The control power terminal VDD of the control module 50 is electrically connected to the voltage output terminal OUT of the voltage conversion module 20. The control module 50 receives the predetermined voltage from the voltage conversion module 20 through the control power terminal VDD. In the embodiment, the control module 50 is a STC12C5410AD chip.

In the embodiment, the control module 50 employs an internal RC oscillator to supply a clock frequency. In other embodiments, the control module 50 employs an external oscillator to supply a clock frequency. The XTAL1 pin of the control module 50 is connected to the external oscillator, and the XTAL2 pin of the control module 50 is left floating. The control module 50 receives the clock frequency through the XTAL1 pin.

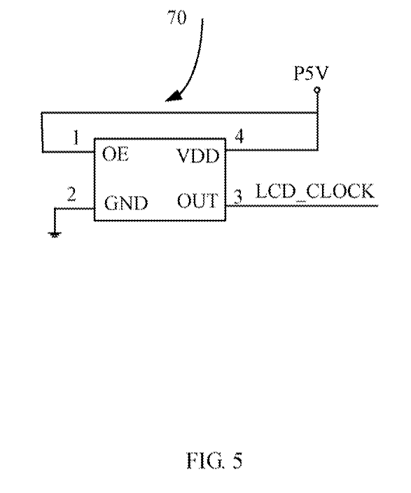

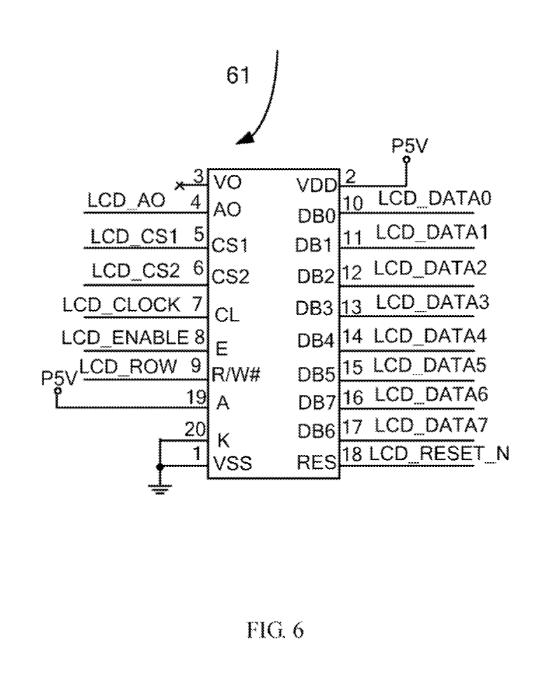

Referring to FIGS. 5-6, in the embodiment, the fan speed testing device 1 further includes a prompt unit 60. The control module 50 is configured to output the predicted rotation speed of the fan 2 and the actual rotation speed of the fan 2 to the user through the prompt unit 60. The prompt unit 60 may be a display unit or a speaker.

In the embodiment, the prompt unit 60 is a display unit 61. The fan speed testing device 1 further includes an oscillation module 70. The voltage conversion module 20 is further electrically connected to the oscillation module 70 and the display unit 61. The voltage conversion module 20 is further configured to supply the predetermined voltage to the oscillation module 70 and to the display unit 61. The oscillation module 70 is electrically connected to the display unit 61. The oscillation module 70 is configured to supply a clock frequency to the display unit 61. The control module 50 is further configured to control the display unit 61 to display the predicted rotation speed of the fan 2 and the first actual rotation speed of the fan 2, as determined by the control module 50.

The oscillation module 70 includes an output enable terminal OE, an oscillation power terminal VDD, and a clock frequency output terminal OUT. The output enable terminal OE and the oscillation power terminal VDD are electrically connected to the voltage output terminal OUT of the voltage conversion module 20. The oscillation module 70 is configured to receive the predetermined voltage from the voltage conversion module 20 through the oscillator power terminal VDD and the output enable terminal OE, and output the clock frequency through the clock frequency output terminal OUT.

The display unit 61 includes a display power terminal VDD, a clock frequency input terminal CL, and eight data input terminals DB0-DB7. The control module 50 further includes eight data output terminals P2.0-P2.7. The display power terminal VDD of the display unit 61 is electrically connected to the voltage output terminal OUT of the voltage conversion module 20. The clock frequency input terminal CL of the display unit 61 is electrically connected to clock frequency output terminal OUT of the oscillation module 70. The eight data input terminals DB0-DB7 of the display unit 61 are respectively connected to the eight data output terminals P2.0-P2.7 of the control module 50. The display unit 61 is configured to receive the predetermined voltage from the voltage output terminal OUT of the voltage conversion module 20 through the display power terminal VDD, and receive the clock frequency from the clock frequency output terminal OUT of the oscillation module 70 through the clock frequency input terminal CL. In the embodiment, the display unit 61 is an LCD1602 unit. The control module 50 is further configured to control the display unit 61 to display the predicted rotation speed of the fan 2 and the first actual rotation speed of the fan 2 through the eight data output terminals P2.0-P2.7 and the eight data input terminals DB0-DB7.

In the embodiment, the first fan connector 30 further includes a second feedback terminal TACH2, the control module 50 further includes a second feedback signal input terminal P1.1/ADC1. When the fan 2 is a four-wire fan, the first fan connector 30 outputs the first feedback signal through the first feedback terminal TACH1. When the fan 2 is a five-wire fan, the first fan connector 30 outputs the first feedback signal and a second feedback signal through the first feedback terminal TACH1 and the second feedback terminal TACH2 respectively. The control module 50 is further configured to receive a second feedback signal from the second feedback terminal TACH2 of the first fan connector 30 through the second feedback signal input terminal P1.1/ADC1, and analyze the second feedback signal to determine a second actual rotation speed of the fan 2. The control module 50 outputs the predicted rotation speed of the fan 2, the first actual rotation speed of the fan 2, and the second actual rotation speed of the fan 2 to the user. In this way, the user can determine whether the predicted or anticipated rotation speed of the fan 2 is between the first actual rotation speed of the fan 2 and the second actual rotation speed of the fan 2, to determine whether the rotation speed of the fan 2 can be characterized as “normal”.

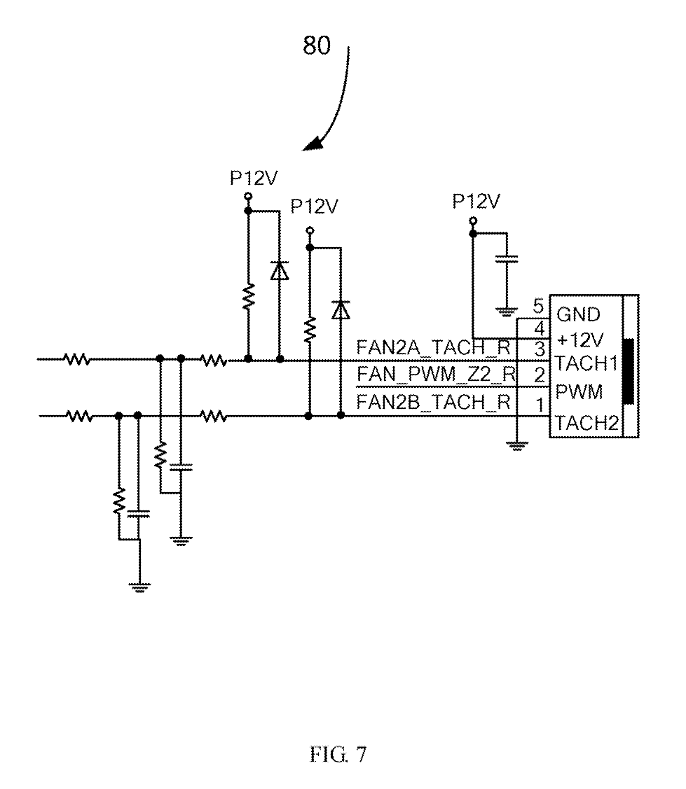

In the embodiment, the fan speed testing device 1 further includes a second fan connector 80. Referring to FIG. 7, the second fan connector 80 is electrically connected to the fan 2 and the voltage conversion module 20 in the same structure and the same manner of connection as the aforementioned first fan connector 30. The second fan connector 80 includes a second signal input terminal PWM, a third signal feedback terminal TACH1, and a fourth signal feedback terminal TACH2. The control module 50 further includes a second PWM signal output terminal PWM1/PCA1/T1/P3.5, a third feedback signal input terminal P1.2/ADC2, and a fourth feedback signal input terminal P1.3/ADC3. The control module 50 is further configured to output the PWM signal to the second signal input terminal PWM of the second fan connector 80 through the second PWM signal output terminal PWM1/PCA1/T1/P3.5, and receive a third feedback signal and a fourth feedback signal from the third signal feedback terminal TACH1 and the fourth signal feedback terminal TACH2 of the second fan connector 80 respectively through the third feedback signal input terminal P1.2/ADC2 and the fourth feedback signal input terminal P1.3/ADC3, analyze the third feedback signal and the fourth feedback signal to determine a third actual rotation speed of the fan 2 and a fourth actual rotation speed of the fan 2, and output the third actual rotation speed of the fan 2 and the fourth actual rotation speed of the fan 2 to the user. Thus, the user can further determine whether the marked or predicted rotation speed of the fan 2 is between the third actual rotation speed of the fan 2 and the fourth actual rotation speed of the fan 2, to further determine whether the operation of the fan 2 can be characterized as “normal”. The number of the fan connectors is not limited to only two.

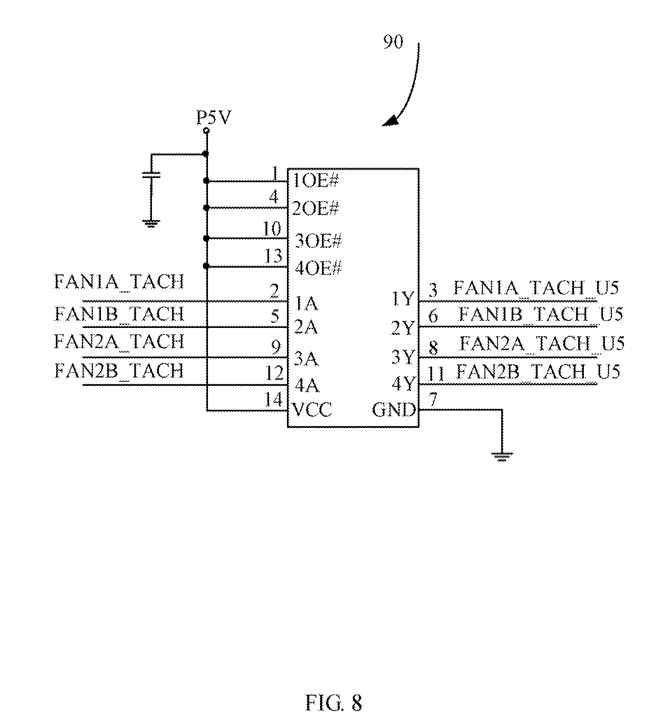

In the embodiment, the fan speed testing device 1 further includes a buffer module 90. Referring to FIG. 8, the buffer module 90 is electrically connected between the first fan connector 30 and the control module 50. In the embodiment, the buffer module 90 is further connected between the second fan connector 80 and the control module 50. The buffer module 90 is configured to synchronize data transmission between the first fan connector 30 and the control module 50, and data transmission between the second fan connector 80 and the control module 50, to prevent the control module 50 from being damaged.

The buffer module 90 includes a first input terminal 1A and a first output terminal 1Y. The first input terminal 1A and the first output terminal 1Y are electrically connected to the first feedback terminal TACH1 of the first fan connector 30 and the first feedback signal input terminal P1.0/ADC0 of the control module 50 respectively. The buffer module 90 is configured to receive the first feedback signal from the first feedback terminal TACH1 of the first fan connector 30 through the first input terminal 1A, and output the first feedback signal to the first feedback signal input terminal P1.0/ADC0 of the control module 50 through the first output terminal 1Y. The buffer module 90 may further include a second input terminal 2A, a third input terminal 3A, a fourth input terminal 4A, and correspondingly include a second output terminal 2Y, a third output terminal 3Y, and a fourth output terminal 4Y. The buffer module 90 further includes four enable terminals 1OE#-4OE# and a buffer power terminal VCC. The four enable terminals 1OE#-4OE# and the buffer power terminal VCC are electrically connected to the voltage output terminal OUT of the voltage conversion module 20. The buffer module 90 is configured to receive the predetermined voltage from the voltage output terminal OUT of the voltage conversion module 20 through the four enable terminals 1OE#-4OE# and the buffer power terminal VCC. In the embodiment, the buffer module 90 is a SN74AHC125PWR chip.

Although the current disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A fan speed testing device comprising:
a power jack configured to receive voltage from a power source;
a voltage conversion module electrically connected to the power jack and configured to convert the voltage received by the power jack to a predetermined voltage;
a first fan connector electrically connected to a fan, the first fan connector being configured to receive the voltage from the power jack and output a PWM signal to the fan, receive a first feedback signal from the fan, and output the first feedback signal;
a dual in-line package switch (DIP switch) capable of offering a plurality of combinations and capable of being set by a user operation; and
a control module electrically connected to the voltage conversion, the DIP switch, and the first fan connector, the control module being configured to receive the predetermined voltage from the voltage conversion module, set a predicted rotation speed of the fan in response to a user operation of setting the combination of the DIP switch, generate the PWM signal corresponding to the predicted rotation speed of the fan, and output the generated PWM signal to the first fan connector; the control module being further configured to receive the first feedback signal from the first fan connector, analyze the first feedback signal to determine an actual rotation speed of the fan, and output the predicted rotation speed of the fan and the first actual rotation speed of the fan by visual or audible signal.

2. The fan speed testing device as described in claim 1, wherein the voltage conversion module comprises a voltage input terminal and a voltage output terminal, the voltage conversion module is configured to receive the voltage from the power jack through the voltage input terminal, convert the received voltage to the predetermined voltage, and output the predetermined voltage through the voltage output terminal.

3. The fan speed testing device as described in claim 2, wherein the first fan connector comprises a fan connection terminal, a first signal input terminal, a first signal feedback terminal, and a connector power terminal; the fan connection terminal is electrically connected to the fan, the first signal input terminal is electrically connected to the control module; the first fan connector is configured to receive the voltage from the power jack through the connector power terminal; receive the PWM signal from the control module through the first signal input terminal and output the PWM signal to the fan through the fan connection terminal; receive the first feedback signal from the fan through the fan connection terminal and output the first feedback signal to the control module through the first signal feedback terminal.

4. The fan speed testing device as described in claim 3, wherein the control module comprises a switch signal input terminal, a first PWM signal output terminal, a first feedback signal input terminal, and a control power terminal; the control module is electrically connected to the DIP switch through the switch signal input terminal; the first PWM signal output terminal of the control module is electrically connected to the first signal input terminal of the first fan connector; the control module is configured to set the predicted rotation speed of the fan in response to the user operation of setting the combination of the DIP switch, and generate the PWM signal corresponding to the set predicted rotation speed of the fan; output the generated PWM signal through the first PWM signal output terminal to the first signal input terminal of the first fan connector; receive the first feedback signal from the first signal feedback terminal of the first fan connector through the first feedback signal input terminal, analyze the first feedback signal to determine the first actual rotation speed of the fan, and output the predicted rotation speed of the fan and the first actual rotation speed of the fan to the user.

5. The fan speed testing device as described in claim 4, further comprising a prompt unit, wherein the control module is configured to control the prompt unit to output the predicted rotation speed of the fan and the first actual rotation speed of the fan to the user.

6. The fan speed testing device as described in claim 5, further comprising an oscillation module, wherein the prompt unit is a display unit; the voltage conversion module is electrically connected to the oscillation module and the display unit, the voltage conversion module is further configured to supply the predetermined voltage to the oscillation module and to the display unit; the oscillation module is electrically connected to the display unit, the oscillation module is configured to supply a clock frequency to the display unit; the control module is further configured to control the display unit to display the predicted rotation speed of the fan and the first actual rotation speed of the fan determined by the control module.

7. The fan speed testing device as described in claim 6, wherein the oscillation module comprises an output enable terminal, an oscillation power terminal, and a clock frequency output terminal; the output enable terminal and the oscillation power terminal are electrically connected to the voltage output terminal of the voltage conversion module; the oscillation module is configured to receive the predetermined voltage from the voltage output terminal of the voltage conversion module through the oscillator power terminal and the output enable terminal, and output the clock frequency through the clock frequency output terminal.

8. The fan speed testing device as described in claim 7, wherein the display unit comprises a display power terminal, a clock frequency input terminal, and eight data input terminals; the control module comprises eight data output terminals; the display power terminal of the display unit is electrically connected to the voltage output terminal of the voltage conversion module; the clock frequency input terminal of the display unit is electrically connected to clock frequency output terminal of the oscillation module; the eight data input terminals of the display unit are respectively connected to the eight data output terminals of the control module; the display unit is configured to receive the predetermined voltage from the voltage output terminal of the voltage conversion module through the display power terminal, and receive the clock frequency from the clock frequency output terminal of the oscillation module through the clock frequency input terminal; the control module is further configured to control the display unit to display the predicted rotation speed of the fan and the first actual rotation speed of the fan through the eight data output terminals and the eight data input terminals.

9. The fan speed testing device as described in claim 4, wherein the first fan connector further comprises a second feedback terminal, the control module further comprises a second feedback signal input terminal; the control module is further configured to receive a second feedback signal from the second feedback terminal of the first fan connector through the second feedback signal input terminal, analyze the second feedback signal to determine a second actual rotation speed of the fan, and output the predicted rotation speed of the fan, the first actual rotation speed of the fan, and the second actual rotation speed of the fan to the user.

10. The fan speed testing device as described in claim 4, further comprising a buffer module, wherein the buffer module is electrically connected between the first fan connector and the control module; the fan speed testing device is configured to synchronize data transmission between the first fan connector and the control module, and prevent the control module from being damaged.

11. The fan speed testing device as described in claim 10, wherein the buffer module comprises a first input terminal and a first output terminal; the first input terminal and the first output terminal are electrically connected to the first feedback terminal of the first fan connector and the first feedback signal input terminal of the control module respectively; the buffer module is configured to receive the first feedback signal from the first feedback terminal of the first fan connector through the first input terminal, and output the first feedback signal to the first feedback signal input terminal of the control module through the first output terminal.

12. The fan speed testing device as described in claim 1, wherein different combinations of the DIP switch correspond to different predicted rotation speeds of the fan.
